(19) United States
(12) Patent Application Publication
(10) Pub. No.: US 2009/0178506 A1
(43) Pub. Date: Jul. 16, 2009

(54) Robot joint drive system

(75) Inventors: Akira Yamamoto, Obu-shi (JP); Mitsuhiro Tamura, Obu-shi (JP); Yoshitaka Shizu, Obu-shi (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Sumitomo Heavy Industries, Ltd.

(21) Appl. No.: 12/318,998

(22) Filed: Jan. 14, 2009

(30) Foreign Application Priority Data
Jan. 15, 2008 (JP) 2008-6111

(51) Int. Cl. B25J 9/02; B25J 18/00; B25J 17/00

(52) U.S. Cl. 74/490.03; 901/15; 901/23

(57) ABSTRACT

The robot joint drive system includes a motor and a reducer for driving a first member and a second member of a robot relative to each other. Output shaft of the reducer is secured to the first member, while a casing of the reducer is secured to the second member. An input shaft of the reducer includes a cantilevered protruded part projecting from the casing of the reducer in a cantilevered manner, and a rotor of the motor is secured to this cantilevered protruded part.

### BACKGROUND OF THE INVENTION:

1. Field of the Invention

The present invention relates to a robot joint drive system having a motor and a reducer, for driving a first member and a second member of a robot relative to each other.

2. Description of the Related Art

In today's manufacturing industries, robots that move almost like a human in doing work such as a “double arm robot” have been actively developed. A robot needs one joint each for each axis of rotation. Therefore, to replace human beings with robots and to make them work in human-like movements, the robot must be configured with much more joints than those of a human. Thus each joint must be made compact as much as possible, otherwise the joint part will take up too much volume relative to an effective length (motion range) of an arm, and the robot arm will end up looking far different from a human arm. It will consequently be more difficult to make it move like a human.

A conventional double arm robot had a drive unit made up of a motor, a reducer, and a power transmission system therebetween. The number of constituent parts was large and downsizing seemed unfeasible. In Japanese Patent Application Laid-Open No. 2007-118177, a double arm robot 16 shown in FIG. 7 and FIG. 8 is proposed, in which the motor and reducer are integrated and formed as a single actuator R1A to R6A and L1A to L6A (of which only the reference numerals R1A and R3A to R6A are actually indicated in the drawings). These actuators R1A to R6A and L1A to L6A are arranged to coincide with respective rotation axes R1J to R6J and L1J to L6J (of which only the reference numerals R1J to R6J are actually indicated in the drawings) of the arms 12 and 14.

With this configuration, since the actuators R1A to R6A and L1A to L6A provide direct drive around the rotation axes R1J to R6J and L1J to L6J of the arms 12 and 14, the number of constituent parts of the arms 12 and 14 can be reduced to minimum, whereby downsizing of the arms 12 and 14 is made possible. This robot's arm therefore looks more like a human arm than that of conventional robots.

However, as is instantly obvious from FIG. 7 and FIG. 8, each arm 12 or 14 still has an awkward shape, largely warping in various different directions along the way, and accordingly, its projected width d is disproportionately larger than the effective length L of the arm 12 or 14. Its appearance is nothing like that of a human arm that extends straight. This is assumed to be because, in the present circumstances, a full review of the motor and the reducer designs in the joint parts has not been accomplished yet. In fact, Japanese Patent Application Laid-Open No. 2007-118177 does not particularly disclose any specific technologies, for example, to make the motor and reducer more compact.

### SUMMARY OF THE INVENTION:

In view of the foregoing problems, various exemplary embodiments of this invention provide a robot joint drive system that enables size reduction of such conventional robot joint drive systems, in particular, size reduction that makes feasible the realization of a robot joint “that looks and moves much more like a human joint.”

The present invention achieves the above object by adopting the following configuration in a robot joint drive system having a motor and a reducer, for driving a first member and a second member of a robot relative to each other: An output shaft of the reducer is secured to the first member, while a casing of the reducer is secured to the second member; an input shaft of the reducer includes a cantilevered protruded part projecting from the casing of the reducer in a cantilevered manner, and a rotor of the motor is secured to this cantilevered protruded part.

As a result of comparative discussion on the configurations of various joints, the inventors of the present application have found out that, in order to achieve an outer appearance closest possible to that of a human arm, it is effective to reduce the “total axial length of the motor and the reducer” as much as possible. Contrary speaking, a shorter total axial length of the motor and the reducer consequently reduces the volume occupied by the joint, and can realize an outer appearance that is very close to that of a human arm.

According to the present invention, the input shaft of the reducer is protruded from the casing of the reducer in a cantilevered manner, and the rotor of the motor is secured to this cantilevered protruded part. This obviates the need of providing a bearing and oil seals on the motor side, enabling a reduction in the total axial length of the motor and the reducer. Moreover, at least the reducer can be provided as a “stand-alone reducer,” which facilitates its inventory management and stock handling.

The present invention provides a robot joint drive system having a motor and a reducer with a reduced total axial length of them. With this system, the joint parts take up less volume, and the robot can be designed to have an arm that looks and moves more like a human arm.

### BRIEF DESCRIPTION OF THE DRAWINGS:

FIG. 1 is a cross-sectional view of a robot joint drive system according to one example of an exemplary embodiment of the present invention;

FIG. 2 is an enlarged view showing major parts of FIG. 1;

FIG. 3A is a (reduced) cross-sectional view taken along the line III-III indicated by the arrows in FIG. 1, and FIG. 3B is a partial enlargement of FIG. 3A;

FIG. 4A is a schematic plan view and FIG. 4B is a side view illustrating the above joint drive system applied to a robot arm;

FIG. 5 is a cross-sectional view of a reducer part illustrating one example of another exemplary embodiment of the present invention;

FIG. 6 is a cross-sectional view illustrating a modified example of the exemplary embodiment shown in FIG. 5;

FIG. 7 is a perspective view illustrating one example of a conventional joint drive system for a robot; and

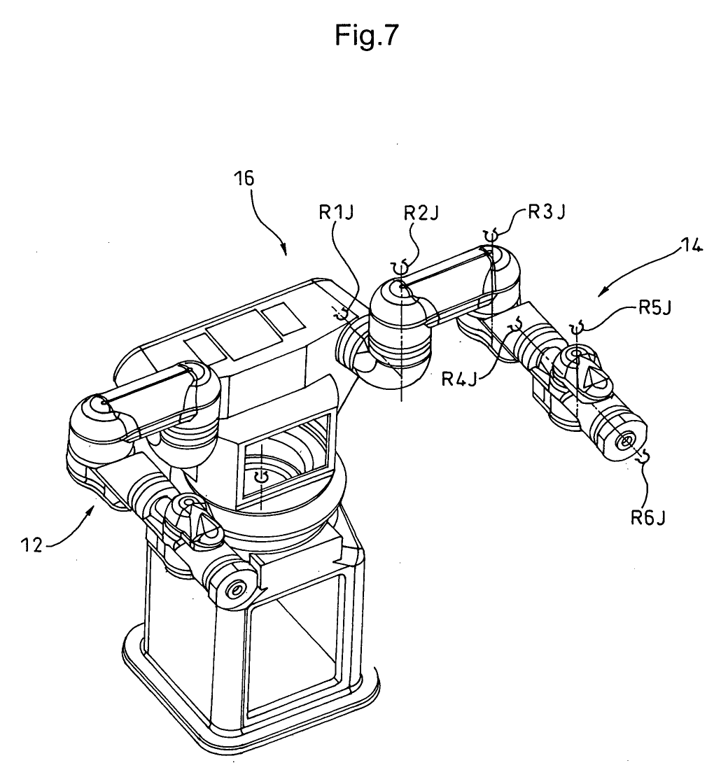

FIG. 8 is a plan cross-sectional view of the robot's right arm.

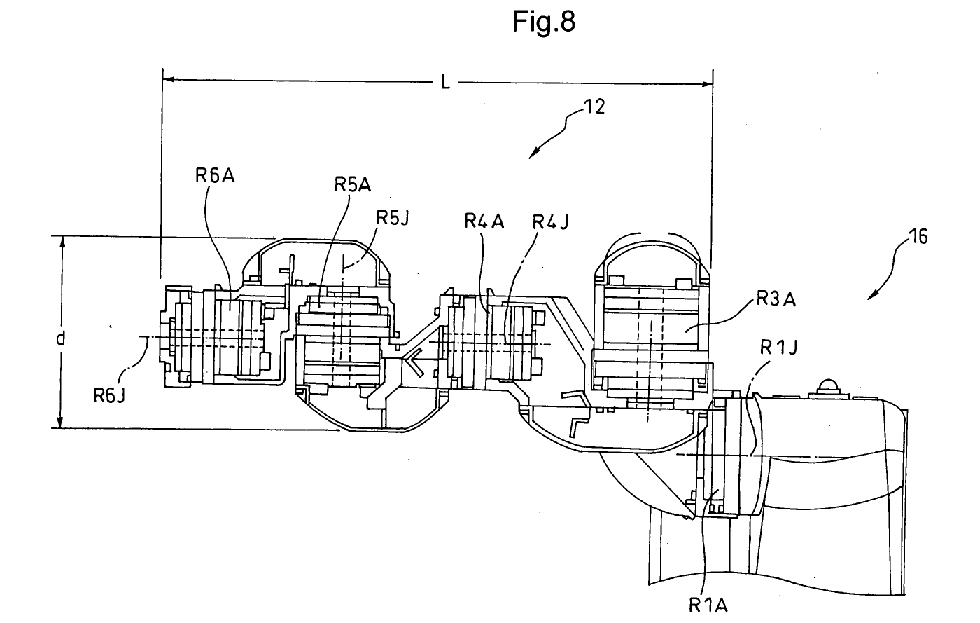

### DETAILED DESCRIPTION OF THE PREFERRED EMBODIMENTS:

One exemplary embodiment of the present invention will be hereinafter described in detail with reference to the drawings.

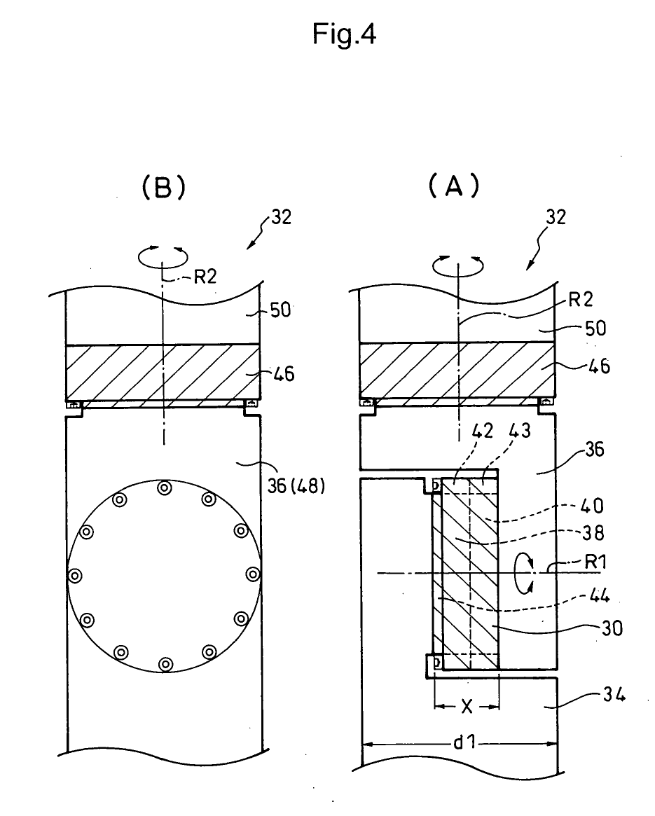

The overall schematic configuration will be first described with reference to FIG. 4A and FIG. 4B. FIG. 4A is a schematic plan view and FIG. 4B is a side view illustrating a robot joint drive system according to one exemplary embodiment of the present invention applied to a robot arm. The robot joint drive system 30 includes a reducer 38 and a flat motor 40, for driving a first member 34 and a second member 36 of the arm 32 of the robot (not shown in its entirety) relative to each other. The first member 34 is secured to an output flange (output shaft) 44 of the reducer 38. A reducer casing 42 is secured to the second member 36 via a motor casing 43. The output flange 44 of the reducer 38 is rotatable around a rotation axis R1 relative to the reducer casing 42. Consequently, the first member 34 that is secured to the output flange 44 of the reducer 38 is rotatable around the rotation axis R1 relative to the second member 36, to which the reducer casing 42 is secured.

This robot joint drive system 30 is capable of driving a joint around any rotation axis, utilizing the relative rotation between the first member and second member. For example, with respect to the example of FIG. 4A and FIG. 4B, another robot joint drive system 46 configured exactly the same as the robot joint drive system 30 may be disposed at a position where the above-mentioned second member 36 is regarded as a first member 48, whereas the part denoted at 50 is regarded as the second member. The robot joint drive system can then be applied as a system for driving the first member 48 and the second member 50 relative to each other around a rotation axis R2.

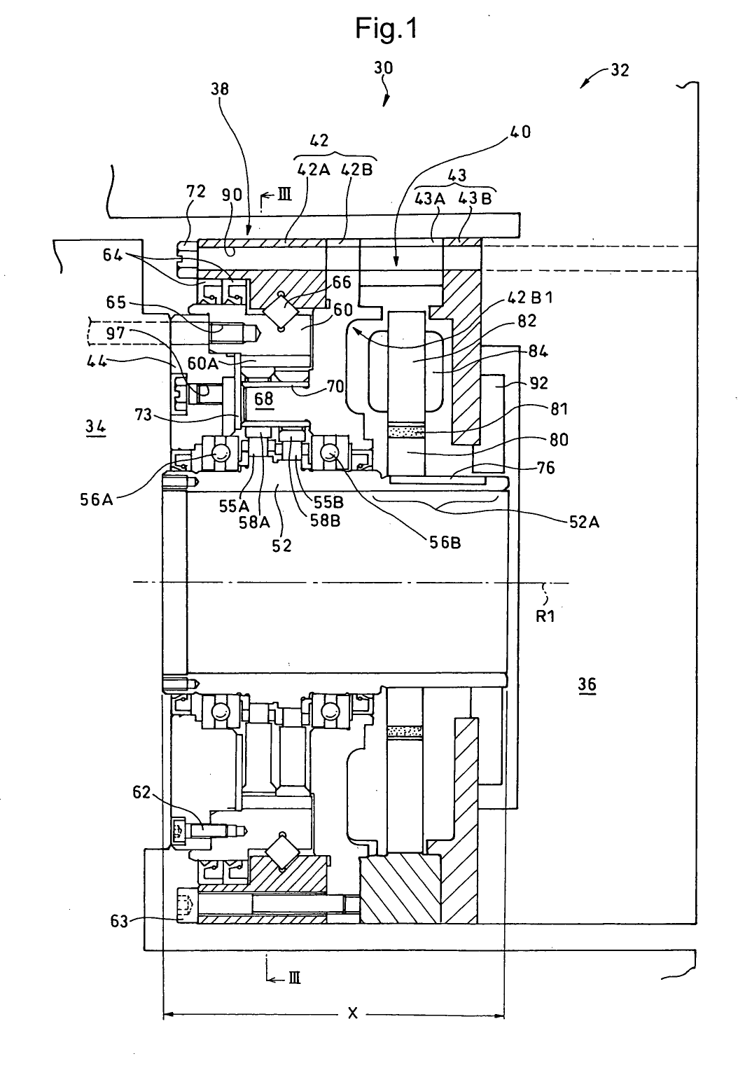

Next, the configuration of the robot joint drive system 30 will be more specifically described with reference to FIG. 1 to FIG. 3A and FIG. 3B.

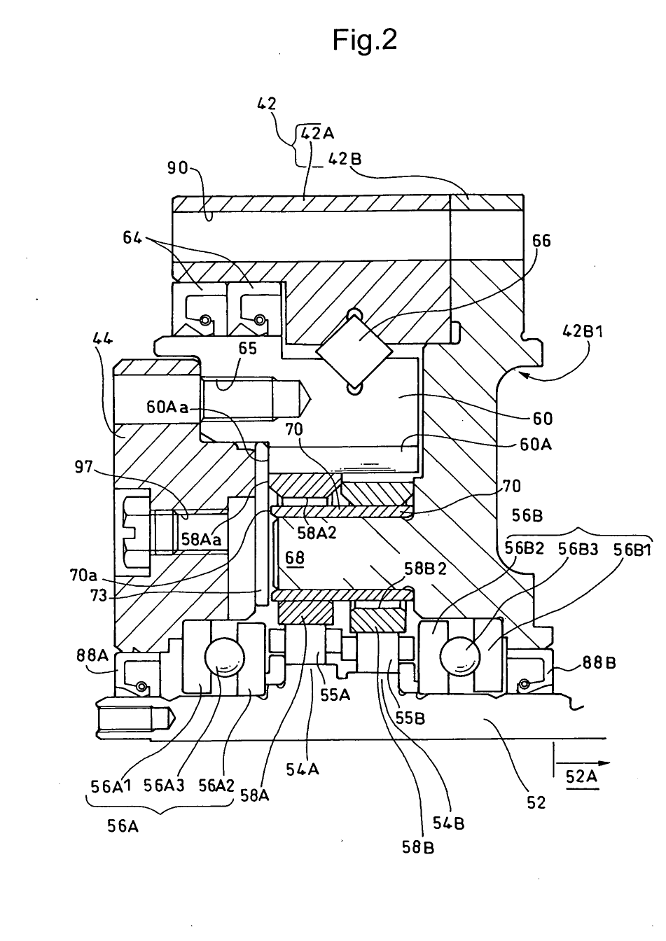

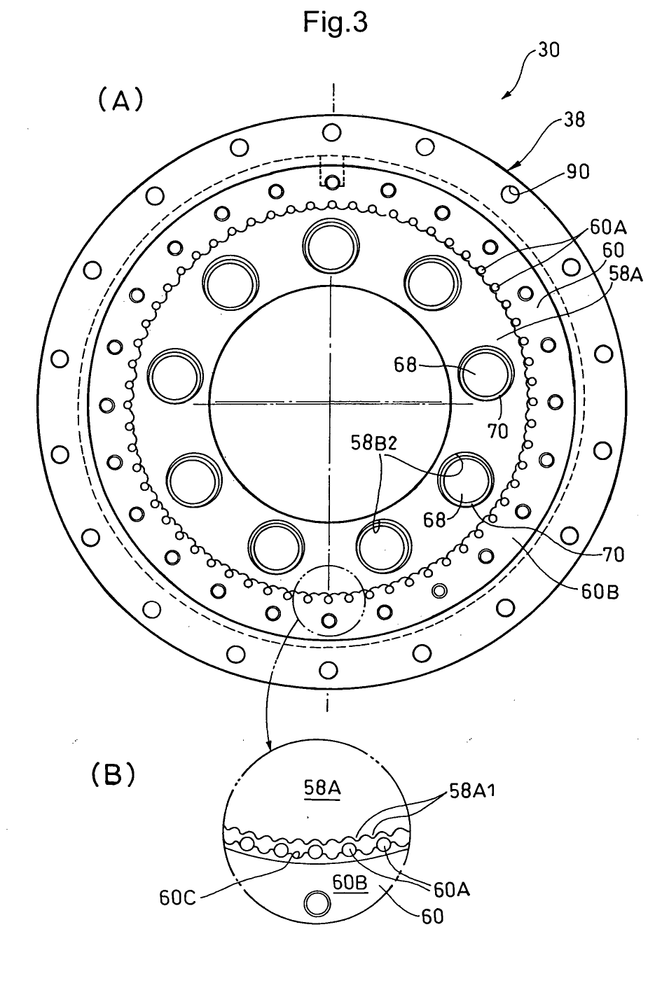

FIG. 1 is an overall cross-sectional view of the robot joint drive system 30, FIG. 2 is an enlarged cross-sectional view showing major parts of FIG. 1, FIG. 3A is a (reduced) cross-sectional view taken along the line III-III in FIG. 1, and FIG. 3B is a partial enlargement of FIG. 3A. As noted above, the robot joint drive system 46 is configured exactly the same.

The reducer 38 is accommodated in the reducer casing 42. The reducer casing 42 is made up of first and second reducer casing bodies 42A and 42B. The reducer 38 in this exemplary embodiment is an eccentric oscillation type reducer having an input shaft 52, and first and second eccentric bodies 54A and 54B. A more detailed description follows.

The input shaft 52 is supported by a pair of first and second thrust bearings 56A and 56B within the reducer casing 42. The input shaft 52 includes a cantilevered protruded part 52A projecting from the reducer casing 42 (more specifically its second reducer casing body 42B) in a cantilevered manner. A rotor 80 of the above-mentioned flat motor 40 is secured to this cantilevered protruded part 52A.

The first and second eccentric bodies 54A and 54B are integrally formed on the outer circumference of the input shaft 52. First and second external gears 58A and 58B are set via first and second rollers 55A and 55B on the radially outer sides of the first and second eccentric bodies 54A and 54B such as to be oscillatingly rotatable respectively. The first and second external gears 58A and 58B internally mesh with the teeth of an internal gear 60, respectively.

The internal teeth of the internal gear 60 are composed of outer pins 60A. Although not shown in FIG. 3A, as shown in the partial enlargement view of FIG. 3B, the main body 60B of the internal gear 60 is formed with outer pin grooves 60C, so that each outer pin 60A is fitted in every other one of these outer pin grooves 60C. The number of external teeth 58A1 and 58B1 (of which only the external teeth 58A1 of the first external gear 58A are shown in FIG. 2) of the first and second external gears 58A and 58B is slightly fewer (by one in the illustrated example) than the number of the outer pin grooves 60C (corresponding to the substantial number of internal teeth). The outer pins 60A are preferably fitted in all of the outer pin grooves 60C, but in the example here, only half of them are fitted, with an aim to reduce costs and the number of assembling steps.

The first and second external gears 58A and 58B are circumferentially offset from each other by 180° by means of the first and second eccentric bodies 54A and 54B. Therefore, the first and second external gears 58A and 58B can oscillate eccentrically with the rotation of the input shaft 52 while keeping the phase difference of 180° therebetween.

In this reducer 38, oil seals 64 and cross rollers 66 are disposed between the first reducer casing body 42A and the internal gear 60. Inner pins 68 are integrally formed to project from the second reducer casing body 42B disposed adjacent the first reducer casing body 42A. The inner pins 68 axially extend through first and second inner pin holes 58A2 and 58B2 of the first and second external gears 58A and 58B to restrict rotation of the first and second external gears 58A and 58B around their axes. Inner rollers 70 are fitted around the inner pins 68. The inner rollers 70 reduce sliding resistance between the inner pins 68 and the first and second inner pin holes 58A2 and 58B2 of the first and second external gears 58A and 58B.

The above-mentioned output flange (output shaft) 44 is disposed on one side of the internal gear 60 opposite from the flat motor. The output flange 44 is integrated with the internal gear 60 together with the first member 34 of the robot by bolts 62, or bolts (not shown) screwed into bolt holes 65. Namely, the first member 34 is integrated with the output flange 44 and can rotate therewith.

In this exemplary embodiment, as shown in FIG. 2, the outer pins 60A of the internal gear 60, the first external gear 58A, and the inner rollers 70 have end faces 60Aa, 58Aa, and 70a that are substantially flush with each other on the side opposite from the flat motor. Furthermore, a planar slip plate 73 is detachably disposed between these three end faces 60Aa, 58Aa, and 70a, and the output flange 44. The slip plate 73 restricts axial movement of the outer pins 60A, the first and second external gears 58A and 58B, and the inner rollers 70.

The reducer casing 42 and the motor casing 43 are integrated with each other together with the second member 36 of the robot arm 32 by bolts 72 (FIG. 1), whereby the reducer 38 and the flat motor 40 are coupled to each other. With this configuration, consequently, the reducer casing 42 is secured to the second member 36, so that the first member 34 secured to the output flange 44 can rotate around the rotation axis R1 relative to the second member 36.

The reducer 38 and the flat motor 40 are coupled to each other and accommodated in their respective casings as will be described below in detail.

The output shaft 52 of the reducer 38 has a cantilevered protruded part 52A projecting from the second reducer casing body 42B of the reducer casing 42 in a cantilevered manner. The rotor 80 of the flat motor 40 is directly connected to this cantilevered protruded part 52A via a key 76. Namely, the input shaft 52 serves also as the motor shaft of the flat motor 40.

The input shaft 52 is supported on both sides on the side of the reducer 38 by the pair of first and second thrust bearings 56A and 56B. One of the characteristic features of this exemplary embodiment is that the input shaft 52 rotating around the rotation axis R1 is supported by “thrust bearings.”

More specifically, the first thrust bearing 56A is disposed at the radial center of the output flange 44. The outer ring 56A1 of the first thrust bearing 56A is secured to the output flange 44, while the inner ring 56A2 thereof is secured to the input shaft 52. Rolling motion of balls 56A3 set between the outer ring 56A1 and the inner ring 56A2 allow relative rotation between the input shaft 52 and the output flange 44 at the first thrust bearing 56A. The outer ring 56A1 of the first thrust bearing 56A does not make contact with the input shaft 52, and the inner ring 56A2 does not make contact with the output flange 44.

On the other hand, the second thrust bearing 56B is disposed at the radial center of the second reducer casing 42B. The outer ring 56B1 of the second thrust bearing 56B is secured to the second reducer casing 42B, while the inner ring 56B2 thereof is secured to the input shaft 52. Rolling motion of balls 56B3 set between the outer ring 56B1 and the inner ring 56B2 allow relative rotation between the input shaft 52 and the second reducer casing 42B at the second thrust bearing 56B. The outer ring 56B1 of the second thrust bearing 56B does not make contact with the input shaft 52, and the inner ring 56B2 does not make contact with the second reducer casing 42B.

The flat motor 40 is accommodated inside the motor casing 43. The motor casing 43 is made up of first and second motor casing bodies 43A and 43B. This flat motor 40 includes, in addition to the above-noted rotor 80 secured to the input shaft 52 and a magnet 81, a stator 82 secured to the first motor casing body 43A and a coil end 84. As mentioned above, the first and second reducer casing bodies 42A and 42B forming the reducer casing 42, the first and second motor casing bodies 43A and 43B forming the motor casing 43, and the second member 36 of the robot arm 32 are all integrated by the bolts 72.

Of these, the second reducer casing body 42B serves as both a reducer front cover and a motor end cover. The coil end 84 of the flat motor 40 takes up much space in the axial direction, and accordingly, this second reducer casing body 42B is formed with a recess 42B1 in a side face on the side on which the flat motor 40 is connected so that this coil end 84 can be accommodated therein when the flat motor 40 is connected.

The reference numeral 63 in FIG. 1 denotes a bolt used when constituting the reducer as a stand-alone reducer. The reference numerals 88A and 88B denote oil seals for preventing leakage of lubricant contained inside the reducer 38, the reference numeral 90 denotes a through hole for inserting the bolt 72, and the reference numeral 92 represents an encoder for detecting rotary position of the flat motor 40.

Next, the operation of this robot joint drive system 30 will be described.

When the rotor 80 rotates by power application to the flat motor 40, the input shaft 52 of the reducer 38, which is also the motor shaft, rotates through the key 76. With the rotation of the input shaft 52, the first and second eccentric bodies 54A and 54B integrally formed on the input shaft 52 start rotating, with the phase difference of 180° being maintained. The rotation of the first and second eccentric bodies 54A and 54B causes eccentric rotation of the first and second external gears 58A and 58B, with the phase difference of 180° in the circumferential direction being maintained.

The existence of this phase difference cancels out radial torques applied to the input shaft 52, whereby the moment alone, which is generated by an axial displacement between the points where torques are applied, is transmitted to the first and second thrust bearings 56A and 56B. Therefore, despite being thrust bearings, they can support the rotation of the input shaft 52 satisfactorily.

The inner pins 68, which are integral with the second reducer casing body 42B, extend through the first and second inner pin holes 58A2 and 58B2 of the first and second external gears 58A and 58B. The inner pins 68 thus restrict rotation of the first and second external gears 58A and 58B around their axes, causing them not to rotate but to oscillate only. This oscillating motion causes the position of engagement between the internal gear 60 and the first and second external gears 58A and 58B to sequentially move over. Since the number of teeth of the internal gear 60 (or the number of outer pin grooves 40C) is different from that of the teeth of the first and second external gears 58A and 58B by one, each rotation with which the position of engagement between the internal gear 60 and the first and second external gears 58A and 58B sequentially moves over (each complete rotation of the input shaft 52) results in the internal gear 60 rotating around its axis by an angle corresponding to the difference in the number of teeth between the internal gear 60 and the first and second external gears 58A and 58B. Consequently, the internal gear 60 rotates by 1/(number of teeth of the internal gear 60) relative to one rotation of the input shaft 52.

This rotation of the internal gear 60 is supported through the cross rollers 66 by the reducer casing 42. The rotation of the internal gear 60 is transmitted to the output flange 44 that is integrated with the internal gear 60 by the bolts 62 or the like, and is output as the rotation of the first member 34, which is secured to the output flange 44, of the robot arm 32.

The joint drive system 30 according to this exemplary embodiment is reduced in the axial length X as it does not include a bearing or oil seals on the side of the flat motor 40. Moreover, because of the second reducer casing body 42B serving as both what is called a reducer cover and a motor cover, the axial length of the system is made shorter in this regard, too.

A detailed description will now be made with regard to the support structure of various members. In this exemplary embodiment, on one side of the first and second external gears 58A and 58B axially opposite from the flat motor is formed a first rigid support system, consisting of rigid components such as the first thrust bearing 56A, the output flange 44, the internal gear 60, the cross rollers 66, and the first reducer casing body 42A, between the input shaft 52 located at the radial center and an outermost circumference of the first reducer casing body 42A.

On the other axial side or on the side of the flat motor of the first and second external gears 58A and 58B, a second rigid support system is formed, consisting of rigid components such as the second thrust bearing 56B and the second reducer casing body 42B, between the input shaft 52 located at the radial center and an outermost circumference of the second reducer casing body 42B.

Furthermore, on one side of the flat motor 40 opposite from the reducer is disposed the second motor casing body 43B, which forms a third rigid support system.

Meanwhile, the first and second reducer casing bodies 42A and 42B, and the first and second motor casing bodies 43A and 43B, are firmly secured by the bolts 72.

This means that, the outermost part is formed by rigid components that are entirely integrated, and furthermore, a total of three rigid support systems are formed in the radial direction, whereby the rigidity of the entire system can be maintained very high. Accordingly, the first and second thrust bearings 56A and 56B have a high support stiffness, and enable stable rotation of the input shaft 52, despite their short bearing span. The high rotation stability is maintained also on the side of the cantilevered protruded part of the input shaft 52 (rotor side of the flat motor 40).

Flat motors 40 used for joint drive of robots usually include an encoder 92 or a brake (not shown in the illustrated example) for rotation control. Since grease is not appropriate for such an encoder 92 or a brake, when a bearing is disposed near the second motor casing body 43B, one or more than two oil seals need to be provided adjacent the bearing, which adds a problem that the axial length of the system is increased. On the other hand, in a configuration in which the flat motor 40 is integrated to the cantilevered protruded part 52A as in the above-described exemplary embodiment, the reducer 38 can be provided independently, which facilitates its design, production, and inventory management. Moreover, the interior of the flat motor 40 is kept oilless, as a result of which no oil seals are necessary, and obviously there is no risk of oil leakage.

The robot joint drive system 30 according to this exemplary embodiment employs a flat motor 40 as the motor, which enables a reduction in the axial length of the system. Moreover, the second reducer casing body 42B is formed with a recess 42B1 in a side face on the side on which the flat motor 40 is connected so as to accommodate the coil end 84 of the flat motor 40. Therefore, while achieving a reduction in the axial length, interference between the coil end 84 and the second reducer casing body 42B is prevented. Furthermore, this second reducer casing body 42B is firmly held between the first reducer casing body 42A and the first motor casing body 43A, as well as extends, through the second thrust bearing 56B, as far as to the input shaft 52 in the radial center, thereby forming the above-noted second rigid support system. Thus a high rigidity is maintained despite the presence of the recess 42B1 or the inner pins 68 or the like.

The configuration with the thrust bearings disposed on the input shaft 52 is actually excellent in terms of long life and cost savings. The reason will be shortly described below. While the bearings used in the present invention should not be limited to any particular types, in order to keep a long life span, as in another exemplary embodiment to be described later, an angular ball bearing or a tapered roller bearing may be used, with a certain preload being applied. Thrust bearings have less backlash (than unpreloaded ball bearings), whereby their support rigidity is high and they outperform in terms of long life and cost savings. In this exemplary embodiment, in particular, radial torques are cancelled out by the eccentric phase difference of 180°, and accordingly, only a radial component of moment, which is generated by the axial displacement between the points where the torques are applied, is transmitted to the input shaft 52, so that the first and second thrust bearings 56A and 56B provide satisfactory support. This has been actually confirmed by the inventors of the present application.

With these designs and configurations combined, the robot joint drive system 30 according to this exemplary embodiment is made compact in the axial direction. Thus, as shown in FIG. 4A, the robot arm 32 in which the system is assembled, can have a smaller projected width d1. This in turn leads to higher design flexibility of the first and second members 34 and 36, so that a robot arm 32 can be made to appear more like a human arm.

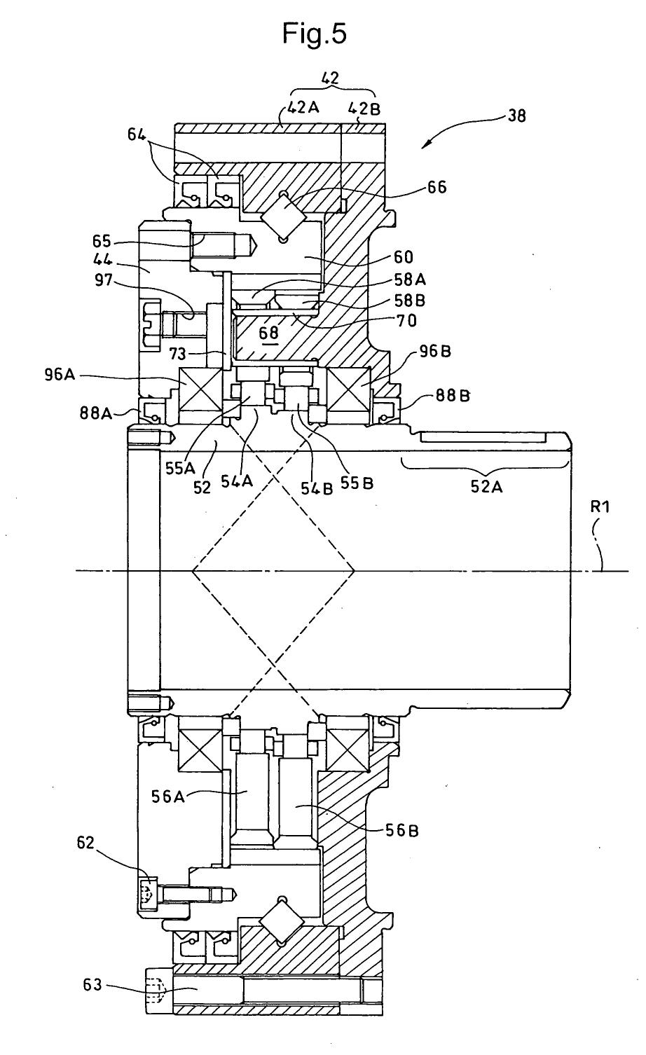

Next, one example of another exemplary embodiment of the present invention will be described with reference to FIG. 5.

In this exemplary embodiment, instead of the first and second thrust bearings 56A and 56B of the previous exemplary embodiment, first and second angular ball bearings 96A and 96B are axially preloaded and mounted in a “front to front” arrangement. As compared to simple ball bearings, angular ball bearings 96A and 96B are designed to be capable of supporting thrust loads in the first place. Therefore, they can maintain high durability even though they are assembled in a preloaded condition. Since angular ball bearings can also support large radial loads, they can be applied to a system with a reducer that is structurally not capable of canceling out radial torques applied to the input shaft, such as a reducer having only one external gear.

Other elements and structures are the same as those of the previous exemplary embodiment, and therefore the same or substantially the same parts are given the same reference numerals and will not be described again.

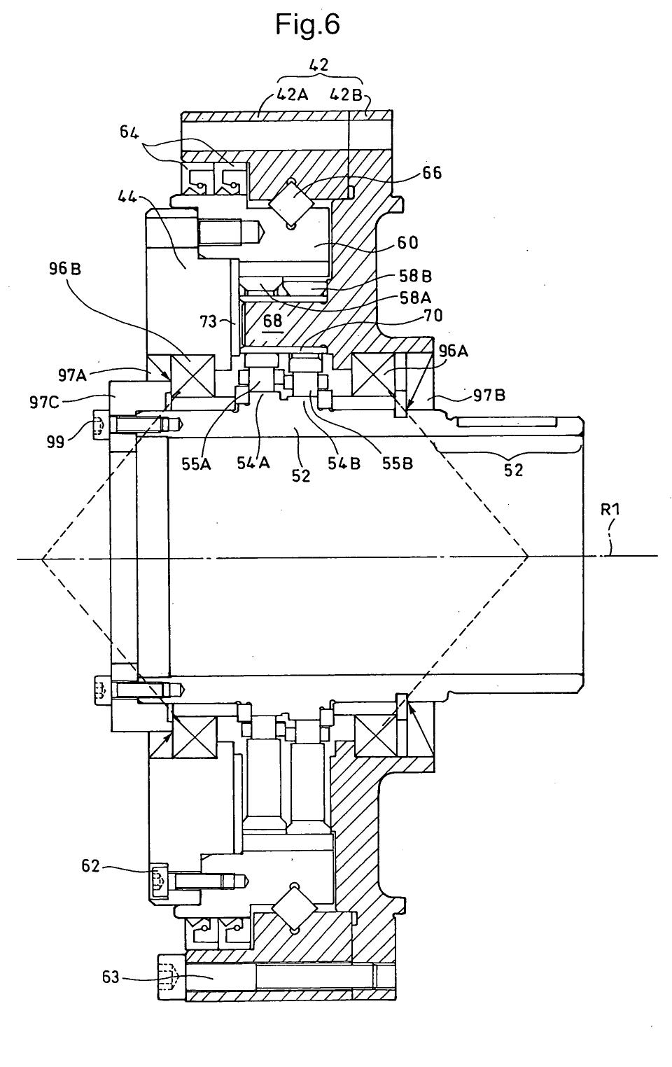

When using these first and second angular ball bearings 96A and 96B for supporting the input shaft 52, they may be preloaded and mounted in a “back to back” arrangement as shown in FIG. 6. With the back to back arrangement, the distance between points of force application is larger than that in the front to front arrangement, whereby the bearing is capable of supporting larger moment loads. Or, the bearing can have a longer life if the moment load is the same. Tapered roller bearings can withstand an even higher capacity than angular ball bearings.

While the above-described exemplary embodiments both employ a flat motor as the motor in order to minimize the axial length of the system, the motor used in the present invention should not be limited to a particular type, and it will be understood that the same effects are equally achieved with various different types of motors.

While the above-described exemplary embodiments employ an eccentric oscillation type reducer as the reducer, the reducer used in the present invention or its structure should not be limited particularly to the eccentric oscillation type. Note, however, the eccentric oscillation type reducer is most preferable because the following effects a) and b) are “achieved at the same time”, as has been described in the foregoing:

Use of a plurality of eccentric bodies and external gears and cancellation of torques by making their respective eccentric phases different from each other enable “thrust bearings” to be used; and

A high reduction ratio (exceeding for example 1/200) necessary for the drive of a robot joint is achieved with single reduction, and with no need of a multi-reduction arrangement, the axial length of the system can be minimized.

The above effects a) and b) can be achieved separately: For example, with respect to the effect a), it can be achieved even with a simple planetary gear reducer. With respect to the effect b), it can be achieved for example with a so-called flexible meshing type reducer in which an external gear flexibly rotates inside an internal gear.

Accordingly, the present invention is advantageously applicable as a robot joint drive system.

The disclosure of Japanese Patent Application No. 2008-006111 filed Jan. 15, 2008 including specification, drawing and claim are incorporated herein by reference in its entirety.

1. A robot joint drive system comprising a motor and a reducer, for driving a first member and a second member of a robot relative to each other, wherein:
an output shaft of the reducer is secured to the first member;
a casing of the reducer is secured to the second member;
an input shaft of the reducer includes a cantilevered protruded part projecting from the casing of the reducer in a cantilevered manner; and
a rotor of the motor is secured to the cantilevered protruded part.

2. The robot joint drive system according to claim 1, wherein the reducer is an eccentric oscillation type reducer, said reducer comprising:
a plurality of eccentric bodies provided at a plurality of locations in an axial direction of the input shaft with different phase positions on an outer circumference of the input shaft;
external gears being set on radially outer sides of the eccentric bodies so as to be oscillatingly rotatable respectively; and
an internal gear with which the external gears internally mesh and which is disposed on a radially outer side of the external gears.

3. The robot joint drive system according to claim 1, wherein the input shaft is supported by a pair of bearings preloaded in a front to front arrangement inside the casing of the reducer.

4. The robot joint drive system according to claim 1, wherein the input shaft is supported by a pair of bearings preloaded in a back to back arrangement inside the casing of the reducer.

5. The robot joint drive system according to claim 1, wherein the input shaft is supported by a pair of thrust bearings inside the casing of the reducer, the thrust bearing having an inner ring being secured to the input shaft and an outer ring being secured to the casing of the reducer.

6. The robot joint drive system according to claim 1, wherein a casing body forming part of the casing of the reducer serves also as a casing body forming part of a casing of the motor, and wherein the casing body serving as two casing bodies is formed with a recess on one side on which the motor is located for accommodating a coil end of the motor.

7. The robot joint drive system according to claim 2, wherein the input shaft is supported by a pair of bearings preloaded in a front to front arrangement inside the casing of the reducer.

8. The robot joint drive system according to claim 2, wherein the input shaft is supported by a pair of bearings preloaded in a back to back arrangement inside the casing of the reducer.

9. The robot joint drive system according to claim 2, wherein the input shaft is supported by a pair of thrust bearings inside the casing of the reducer, the thrust bearing having an inner ring being secured to the input shaft and an outer ring being secured to the casing of the reducer.
